(19) United States
(12) Patent Application Publication
(10) Pub. No.: US 2016/0217328 A1
(43) Pub. Date: Jul. 28, 2016

(54) IMAGE AND VIDEO PROCESSING AND OPTIMIZATION

(71) Applicant: Danielle YANAI, Ganei Yehudah (IL)

(72) Inventors: Danielle YANAI, Ganei Yehudah (IL); Guy SCHORY, San Francisco, CA (US)

(21) Appl. No.: 15/025,933

(22) PCT Filed: Sep. 29, 2014
(86) PCT No.: PCT/IL2014/050854

§ 371 Date: Mar. 30, 2016

Related U.S. Application Data
(60) Provisional application No. 61/884,868, filed on Sep. 30, 2013.

(51) Int. Cl. G06K 9/00; G06K 9/03; H04N 5/232; G11B 27/031; G11B 27/34

(52) U.S. Cl. CPC G06K 9/00671; G11B 27/031; G11B 27/34; H04N 5/23222; G06K 9/036

(57) ABSTRACT

A system comprising a computer-readable storage medium storing at least one program and a computer-implemented method for capturing an optimal quality image are presented. Consistent with some embodiments, the method may include receiving a video stream from a camera, and calculating a plurality of image attribute scores for the video stream. The method may further include causing a client device to automatically store a video frame from the video stream in response to determining that at least a portion of the plurality of image attribute scores are above a predefined threshold. The method may further include receiving a video stream from a camera associated with a client device and providing to the user of the client device video templates containing video-recording directions which are adapted to predetermined criteria that correspond to the purpose of video-recording, the type of activity to be presented in said video stream and the medium where the video content will be published.

### FIELD OF THE INVENTION

The subject matter disclosed herein generally relates to image processing. Specifically, the present disclosure relates to capturing and optimizing images and video streams.

### BACKGROUND OF THE INVENTION

Currently, a number of websites allow users to submit multimedia content in the form or audio, images, video, or combinations thereof. Multimedia content may be submitted for a variety of purposes. For example, social networks allow users to publicly share collections of photographs or videos and receive feedback from other users. In another example, ecommerce marketplaces that allow users to sell goods online may also allow users to submit images of products to be sold. These types of user-submitted content are often lacking in quality, and as a result, these types of content may not be fit for their intended purpose, or may not garner the amount of attention that is possible with higher quality content.

It is therefore desired to provide a user with tools for increasing the quality of user-submitted content.

It is an object of the present invention to provide a method and system for increasing the quality of user-submitted content.

It is another object of the present invention to provide a method and system for customizing and optimizing types of content to their intended purpose in order to garner the maximum amount of possible attention to the user-submitted content.

Other objects and advantages of the invention will become apparent as the description proceeds.

### SUMMARY OF THE INVENTION

The present invention is directed to a method for capturing and optimizing images and video streams, according to which a video stream is received from a camera associated with a client device and a plurality of image attribute scores are calculated for the video stream. A processor of a machine determines that at least a portion of the plurality of image attribute scores are above a predefined threshold. In response to determining that at least the portion of the plurality of image attribute scores are above the predefined threshold, the client device automatically stores a particular video frame included in the video stream in a persistent format in a machine-readable medium of the client device.

The client device may also be adapted to display an alert in response to determining that at least the portion of the plurality of image scores are above the predefined threshold, the alert notifying a user that the video stream includes an image of optimal quality.

An overall image score may be calculated for the particular video frame using the plurality of image attribute scores. The overall image score provides an overall measure of quality of the particular video frame.

It may be determined that at least one image attribute score of the plurality of image attribute scores is below a predefined threshold and in response to determining that the at least one image attribute score of the plurality of image attribute scores is below the predefined threshold, textual feedback including a suggestion to improve the at least one image attribute score is generated and the textual feedback is displayed on the client device.

The client device may be adapted to present an indicator of at least one of the plurality of image attribute scores.

An item identifier that identifies an item included in the video stream may be received and imaging directions corresponding to the item identifier may be accessed, where the imaging directions, which are presented on the client device, relate to a manner in which the item is to be depicted in the video stream. The imaging directions may include analytic data regarding previous images depicting similar items.

The plurality of image attribute scores may provide a measure of at least one of angle, brightness, color, composition, saturation, background clutter, or resolution.

Calculation of the plurality of image attribute scores may be performed continuously until the determining that at least the portion of the plurality of image attribute scores is above the predefined threshold.

The particular video frame may be uploaded to a network server and a product listing page may be generated using the particular video frame, such that the product listing page corresponds to an item depicted in the particular video frame.

The plurality of image attribute scores may be used to rank the product listing page in a list of search results.

The present invention is also directed to a system for capturing and optimizing images and video streams, which comprises a machine-readable medium; an analysis module, including at least one processor, configured to receive a video stream from a camera, the analysis module further configured to calculate a plurality of image attribute scores for the video stream; and an optimization module configured to determine that a particular combination of the plurality of image attribute scores is above a predefined threshold, the optimization module further configured to cause a particular video frame included in the video stream to be stored in a persistent format in the machine-readable medium in response to determining that the particular combination of the plurality of image attribute scores is above a predefined threshold.

The particular video frame may be stored in the machine-readable medium without intervention from a user.

The analysis module may calculate the plurality of image attributes scores using data received from a plurality of sensors coupled to the camera and the plurality of image attribute scores, based on image attribute measurements provided by the plurality of sensors being in a particular range.

The analysis module may be configured to calculate an overall image score for the particular video frame, the overall image score providing a measure of overall quality of the particular video frame.

The particular combination of the plurality of image attribute scores may be the overall image score.

The system may further comprise an instructional module configured to perform operations, comprising:
determining that a particular image attribute score of the plurality of image attribute scores is below a predefined threshold;
in response to determining that the particular image attribute score of the plurality of image attribute scores is below the other predefined threshold, generating textual feedback including a suggestion to improve the particular image attribute score; and
causing the textual feedback to be displayed on a client device associated with the camera.

The system may further comprise:
an identification module configured to receive an item identifier, the item identifier identifying an item included in the video stream; and
an instructional module configured to access imaging directions corresponding to the item, the instructional module further configured to cause the imaging directions to be presented in conjunction with the video stream, the imaging directions relating to a manner in which the item is to be depicted in the video stream.

The present invention is further directed to a non-transitory machine-readable storage medium comprising instructions that, when executed by one or more processors of a machine, cause the machine to perform operations, which comprise receiving a video stream from a camera associated with a client device; calculating a plurality of image attribute scores for the video stream; determining that at least a portion of the plurality of image attribute scores are above a predefined threshold; and in response to determining that at least the portion of the plurality of image attribute scores are above the predefined threshold, causing the client device to automatically store an image in a persistent format in a machine-readable medium of the client device, the image being a single frame from the video stream.

The present invention is also directed to a method for capturing and optimizing a video stream, comprising the following steps:

receiving a video stream from a camera associated with a client device; providing to the user of said client device, video templates containing video-recording directions which are adapted to a predetermined criteria that correspond to:
the purpose of video-recording;
the type of activity to be presented in said video stream; and
the medium where the video content will be published.

One or more top photos (which are the most optimal photos extracted from the recorded video stream) may be presented to the user, who is allowed to add a selected top photo as cover photo to the recorded video stream or to use a selected top photo which is displayed online.

Each recorded video clip may be divided into several segments, which are then automatically recomposed to create variations of the recorded video clip. One or more virtual representations (such as video clips, images, title and description) of products may be tagged and embedded into a video clip using the video template. The embedded virtual representations of a product may be displayed on top of the video clip, while the product is being discussed in said video clip.

It is also possible to automatically add meta-data to the video clip.

Multiple users can create videos collaboratively by recording segments in different times and/or locations and automatically synthesize them into a single, cohesive video.

### BRIEF DESCRIPTION OF THE DRAWINGS

In the drawings:

FIG. 1 is a network diagram depicting a network system having a client-server architecture configured for exchanging data over a network, according to an example embodiment;

FIG. 2 is a block diagram illustrating an example embodiment of multiple marketplace applications, which are provided as part of the network system;

FIG. 3 is a block diagram illustrating an example embodiment of multiple modules forming imaging applications;

FIG. 4 is an interaction diagram illustrating an example method of capturing an optimal quality image, according to some embodiments;

FIG. 5 is a flowchart illustrating an example method of capturing an optimal quality image, according to some embodiments;

FIG. 6 is a flowchart illustrating a method for capturing an optimal quality image, according to some embodiments;

FIG. 7 is a flowchart illustrating a method for providing users with real-time feedback regarding image quality, according to some embodiments;

FIG. 8A is an interface diagram illustrating a video stream being produced on a client device along with indicators of image attribute scores, according to some embodiments;

FIG. 8B is an interface diagram illustrating a video stream being produced on the client device along with feedback related to an image attribute, according to some embodiments;

FIG. 8C is an interface diagram illustrating an optimal quality image captured from the video stream produced on the client device, according to some embodiments;

FIG. 8D is an interface diagram illustrating a menu including options for enhancing the image, according to some embodiments;

FIG. 8E is an interface diagram illustrating an image enhancement feature, according to some embodiments;

FIG. 8F is an interface diagram illustrating an enhanced image, according to some embodiments;

FIG. 9 is a diagrammatic representation of a machine in the example form of a computer system within which a set of instructions for causing the machine to perform any one or more of the methodologies discussed herein may be executed; and

FIG. 10 shows a schematic view of a product card.

### DETAILED DESCRIPTION OF PREFERRED EMBODIMENTS

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

A large majority of online user submissions of multimedia content are often of poor quality and often do not depict an intended subject with clarity and in a manner that is aesthetically pleasing for other users who may view such media. To improve user submissions, some websites and other online services provide a number of tutorials, which simply offer general guidance related to photography. However, these solutions do not provide users with real-time guidance in capturing quality images while the user is actually attempting to capture these images.

Aspects of the present disclosure describe systems and methods for capturing an optimal quality image. For purposes of this disclosure, an “optimal quality image” (or an “image of optimal quality”) means a high quality image that clearly depicts a particular subject. The subject of an image may be an object or set of objects that appears in the foreground of an image and dominate the image, such that the object or set of objects are the main thing being depicted in the image. A subject of an image may, for example, be an item, a person, a landscape, an animal, a piece of architecture, or the like.

Consistent with some embodiments, the methods may include receiving an item identifier, which identifies an item to be depicted in an image yet to be captured. The method may further include presenting imaging directions to a user including particular instructions for photographing (e.g., capturing an image of) the item (e.g., using an integrated camera of a mobile device). In other words, the imaging directions provide users with a detailed explanation of how a particular item should be depicted in an image or set of images. The imaging directions may relate to a setting, background, angle, orientation, or proximity of the camera with respect to the subject of the image.

The method may further include receiving a video stream from a camera and determining a plurality of image attribute scores for the video stream. The user may be presented with real-time feedback about quality of the images being produced in the video stream based on the plurality of image attribute scores. The method may further include detecting an optimal quality image from the video stream based on the plurality of image attribute scores. The optimal quality image may be automatically recorded and stored on the mobile device.

From the user's perspective, the method may begin with a user launching an imaging application (e.g., a camera application) on the user's mobile device. The user may then be prompted by the imaging application to input an identifier of a subject the user wishes to depict in an image. Once the user identifies the subject, the user may be provided with a set of instructions related to a manner in which the user should photograph the subject in one or more images. The user may initiate the video stream from within the imaging application. Prior to capturing an image, the user may be provided with textual feedback in conjunction with the video stream. The feedback may relate to the quality or desirability of the images being produced in the video stream. In some embodiments, the user may manually cause the imaging application to record and store an image from the video stream. In some embodiments, the image may be stored automatically by the imaging application in response to an image of optimal quality being detected.

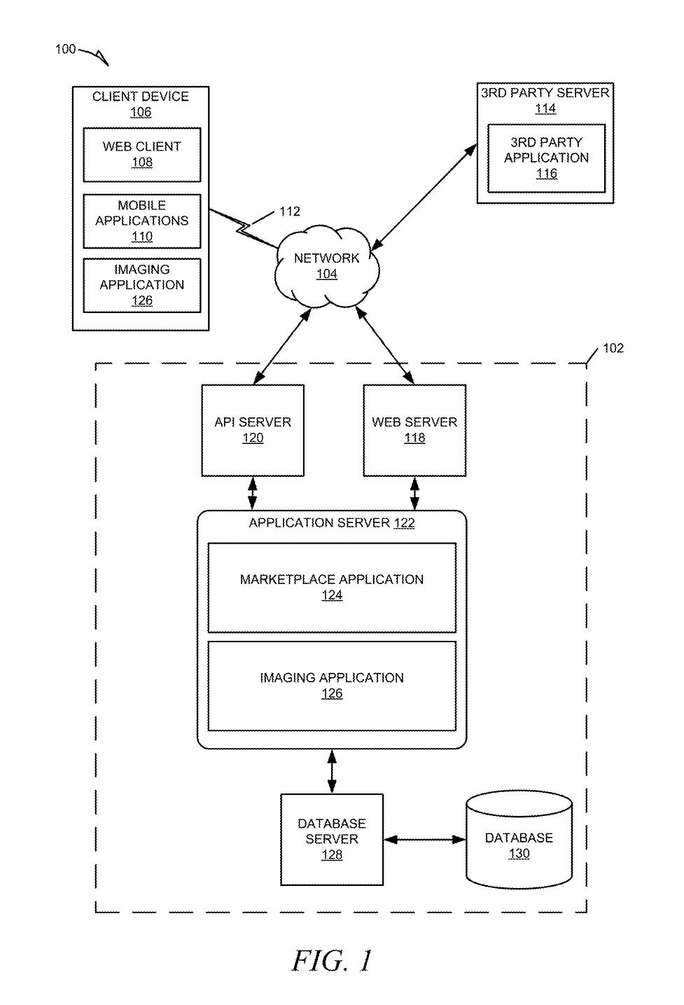

FIG. 1 is a network diagram depicting a network system 100, according to one embodiment, having a client-server architecture configured for exchanging data over a network. The network system 100 may include a network-based content publisher 102 in communication with a client device 106 and a third party server 114. In some example embodiments, the network-based content publisher 102 may be a network-based marketplace.

The network-based content publisher 102 may communicate and exchange data within the network system 100 that may pertain to various functions and aspects associated with the network system 100 and its users. The network-based content publisher 102 may provide server-side functionality, via a network 104 (e.g., the Internet), to client devices such as, for example, the client device 106. The client device 106 may be operated by users who use the network system 100 to exchange data over the network 104. These data exchanges may include transmitting, receiving (communicating), and processing data to, from, and regarding content and users of the network system 100. The data may include, but are not limited to, images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

In various embodiments, the data exchanged within the network system 100 may be dependent upon user-selected functions available through one or more client or user interfaces (UIs). The UIs may be associated with a client device, such as the client device 106 executing a web client 108. The web client 108 may be in communication with the network-based content publisher 102 via a web server 118. The UIs may also be associated with one or more mobile applications 110 executing on the client device 106, such as a client application designed for interacting with the network-based content publisher 102, or the UIs may be associated with the third party server 114 (e.g., one or more servers or client devices) hosting a third party application 116.

The client device 106 may interface via a connection 112 with the network 104 (e.g., the Internet or a wide area network (WAN)). Depending on the form of the client device 106, any of a variety of types of connection 112 and network 104 may be used. For example, the connection 112 may be a Code Division Multiple Access (CDMA) connection, a Global System for Mobile communications (GSM) connection, or another type of cellular connection. Such a connection 112 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection 112 may be a Wireless Fidelity (Wi-Fi, IEEE 802.11x type) connection, a Worldwide Interoperability for Microwave Access (WiMAX) connection, or another type of wireless data connection. In such an embodiment, the network 104 may include one or more wireless access points coupled to a local area network (LAN), a WAN, the Internet, or another packet-switched data network. In yet another example, the connection 112 may be a wired connection, for example an Ethernet link, and the network 104 may be a LAN, a WAN, the Internet, or another packet-switched data network. Accordingly, a variety of different configurations are expressly contemplated.

FIG. 1 also illustrates the third party application 116 executing on the third party server 114 that may offer one or more services to users of the client device 106. The third party application 116 may have programmatic access to the network-based content publisher 102 via a programmatic interface provided by an application program interface (API) server 120. In some embodiments, the third party application 116 may be associated with any organization that may conduct transactions with or provide services to the users of the client device 106.

Turning specifically to the network-based content publisher 102, the API server 120 and the web server 118 are coupled to, and provide programmatic and web interfaces respectively to, an application server 122. As illustrated in FIG. 1, the application server 122 may be coupled via the API server 120 and the web server 118 to the network 104, for example, via wired or wireless interfaces. The application server 122 is, in turn, shown to be coupled to a database server 128 that facilitates access to a database 130. In some examples, the application server 122 can access the database 130 directly without the need for the database server 128. The database 130 may include multiple databases that may be internal or external to the network-based content publisher 102.

The application server 122 may, for example, host one or more applications, which may provide a number of content publishing and viewing functions and services to users who access the network-based content publisher 102. For example, the network-based content publisher 102 may host a marketplace application 124 that may provide a number of marketplace functions and services to users such as publishing, listing, and price-setting mechanisms whereby a seller may list (or publish information concerning) goods or services (collectively referred to as “products”) for sale, a buyer can express interest in or indicate a desire to purchase such goods or services, and a price can be set for a transaction pertaining to the goods or services.

In order to make listings available via the network-based content publisher 102 as visually informative and attractive as possible, the application servers 122 may host an imaging application 126, which users may utilize to capture, optimize, and upload images, videos, or other display elements for inclusion within listings. The imaging application 126 also operates to incorporate images, videos, and other display elements within marketplace listings. The imaging application 126 may also provide a number of image optimization services to be used with images, videos, and other display elements included within existing marketplace listings. In some embodiments, the imaging application 126 may be implemented as a standalone system or software program (e.g., an application) hosted on the client device 106.

The database 130 may store data pertaining to various functions and aspects associated with the network system 100 and its users. For example, user profiles for users of the network-based content publisher 102 may be stored and maintained in the database 130. Each user profile may comprise user profile data that describes aspects of a particular user. The user profile data may, for example, include demographic data (e.g., gender, age, location information, employment history, education history, contact information, and familial relations), user preferences and interests, social data, and financial information (e.g., account number, credential, password, device identifier, user name, phone number, credit card information, bank information, and a transaction history).

While the marketplace and imaging applications 124 and 126 are shown in FIG. 1 to all form part of the network-based content publisher 102, it will be appreciated that, in alternative embodiments, the imaging application 126 may form part of a service that is separate and distinct from the network-based content publisher 102. Further, while the network system 100 shown in FIG. 1 employs a client-server architecture, the present inventive subject matter is, of course, not limited to such an architecture, and could equally well find application in an event-driven, distributed, or peer-to-peer architecture system, for example. The various modules of the application server 122 may also be implemented as standalone systems or software programs, which do not necessarily have networking capabilities.

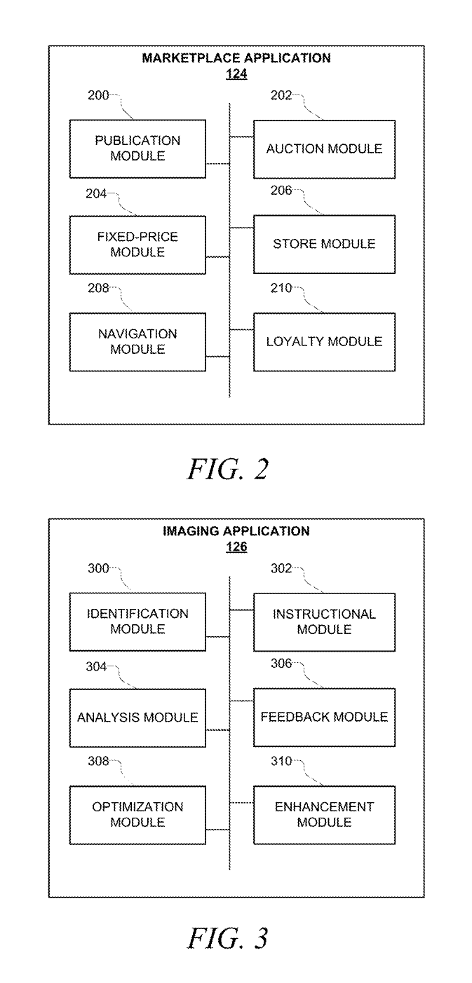

FIG. 2 is a block diagram illustrating an example embodiment of multiple modules forming the marketplace application 124, which is provided as part of the network-based content publisher 102. The marketplace application 124 is shown as including a publication module 200, an auction module 202, a fixed-price module 204, a store module 206, a navigation module 208, and a loyalty module 210, all configured to communicate with each other (e.g., via a bus, shared memory, a switch, or application programming interfaces (APIs)). The various modules of the marketplace application 124 may, furthermore, access one or more databases 130 via the database servers 128, and each of the various modules of the marketplace application 124 may be in communication with one or more of the third party applications 116. Further, while the modules of the marketplace application 124 are discussed in the singular sense, it will be appreciated that in other embodiments multiple modules may be employed.

The marketplace application 124 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 124 is shown to include at least one publication module 200 and at least one auction module 202, which support auction-format listing and price setting mechanisms (e.g., English, Dutch, Vickrey, Chinese, Double, Reverse auctions). The auction module 202 may also provide a number of features in support of such auction-format listings, such as a reserve price feature whereby a seller may specify a reserve price in connection with a listing, and a proxy-bidding feature whereby a bidder may invoke automated proxy bidding.

The fixed-price module 204 supports fixed-price listing formats (e.g., the traditional classified-advertisement-type listing or a catalogue listing) and buyout-type listings.

The store module 206 may allow sellers to group their item listings (e.g., goods or services) within a “virtual” store, which may be branded and otherwise personalized by and for the sellers. Such a virtual store may also offer promotions, incentives, and features that are specific and personalized to a relevant seller. In one embodiment, the listings or transactions associated with the virtual store and its features may be provided to one or more users.

Navigation of the network-based content publisher 102 may be facilitated by the navigation module 208. For example, the navigation module 208 may, inter alia, enable key word searches of listings published via the network-based content publisher 102. The navigation module 208 may also allow users via an associated UI to browse various category, catalogue, inventory, social network, and review data structures within the network-based content publisher 102.

The network-based content publisher 102 itself, or one or more parties that transact via the network-based content publisher 102, may operate loyalty programs that are supported by the loyalty module 210. For example, a buyer may earn loyalty or promotions points for each transaction established or concluded with a particular seller, and be offered a reward for which accumulated loyalty points can be redeemed.

FIG. 3 is a block diagram illustrating an example embodiment of multiple modules forming the imaging application 126. The imaging application 126 is shown as including an identification module 300, an instructional module 302, an analysis module 304, a feedback module 306, an optimization module 308, and an enhancement module 310, all configured to communicate with each other (e.g., via a bus, shared memory, a switch, or application programming interfaces (APIs)). The various modules of the imaging application 126 may furthermore access the database 130 via the database servers 128, and may be in communication with one or more of the third party applications 116. Each of the modules of the imaging application 126 may further access data stored on the client device 106.

While the modules of the imaging application 126 are discussed in the singular sense, it will be appreciated that in other embodiments multiple modules may be employed. Moreover, any two or more of these modules may be combined into a single module, and the functions described herein for a single module may be subdivided among multiple modules.

In some embodiments, the modules of the imaging application 126 may be hosted on dedicated or shared server machines that are communicatively coupled to enable communications between server machines. In some embodiments, the client device 106 may receive, store, and execute one or more of the modules 300-310.

The identification module 300 may be configured to identify a subject of an image or video. A subject of an image refers to a main object or set of objects being depicted in an image. The subject may, for example, be an item, a person, a landscape, an animal, a piece of architecture, or the like. In some instances, the subject of the image may be an item to be offered for sale on the network-based content publisher 102. In these instances, the identification modules 300 may identify the subject of the image using an item identifier received from a user (e.g., via a mobile device of the user). The item identifier may be selected from a prepopulated list or supplied by the user (e.g., entered by the user as freeform text). The item identifier may, for example, be a Universal Product Code (UPC), serial number, or other unique identifier corresponding to a product (e.g., a consumer product available for sale from the user).

In some embodiments, the identification modules 300 may automatically detect the subject using known image recognition techniques. The identification modules 300 may also employ geopositional information provided by the client device 106 in conjunction with image recognition techniques to identify the subject of the image.

The instructional module 302 may provide users with imaging directions related to the photographing or capturing video of a particular subject. The imaging directions may be accessed from a repository (e.g., database 130) of imaging directions. The imaging directions provide users with detailed instructions explaining how a particular subject should be depicted in an image or set of images. The imaging directions may include text, images, audio, video, or combinations thereof. The imaging directions may relate to the angle, orientation, or proximity of the camera with respect to the subject of the image. The instructions provided by the instructional modules 302 may be particular to the subject of the image. For example, a user intending to capture an image of a purse for inclusion in a marketplace listing may be instructed to “Capture the following three images on a solid background: 1) front view; 2) side view; and 3) close up of fabric.” In another example, the instructional modules 302 may provide a user with an example image similar to the image the user intends to take (e.g., an image depicting the same subject).

The imaging directions provided by the instructional modules 302 may also include analytics based on data about previous images depicting a similar subject. These analytics may relate to the angle, orientation, brightness, color, composition, saturation, background, resolution (e.g., pixel density), size of subject in relation to entire image, or other characteristics of the image. For example, the imaging directions provided by the instructional modules 302 may alert a user who is intending to capture an image of a particular item to be included in an online marketplace listing that marketplace listings having images with white backgrounds have a 60% greater chance of being sold than listings for the same item with images that do not have white backgrounds. The analytics may be retrieved by the instructional modules 302 from the database 130.

The analysis module 304 may receive and process a video stream from a camera (e.g., included as part of the client device 106). The video stream may comprise a series of frames (e.g., images) successively recorded by a camera and may be displayed as a video, for example, on the display of the client device 106. In some embodiments, the processing of the video stream may include determining scores, respectively, for image attributes of the video stream (referred to herein as “image attribute scores”). The image attributes describe various visual characteristics of an image included in the video stream. The image attributes may, for example, relate to the angle, brightness, color, composition, saturation, background of the image, resolution (e.g., pixel density), distance of the camera from the subject, or size of subject in relation to entire image. As the position and orientation of the client device changes (e.g., due to manipulation of the client device and its built-in camera by the user), the various image attributes of the video stream may vary. To compensate for these changes, the analysis modules 304 may continuously update and recalculate the image attribute scores in real time.

The determination of image attribute scores performed by the analysis module 304 may be based on measurements associated with image attributes that are received from one or more sensors embedded in the device having the camera that produces the video stream (e.g., client device 106). For example, the image attribute score related to image angle may be derived from an orientation measurement (e.g., measured in degrees) received from a gyroscope sensor included in the client device 106. In another example, the image attribute score related to the distance of the camera from the subject of the image may be based on a distance measurement (e.g., measured in meters) provided by a proximity sensor embedded in the client device 106. In yet another example, the image attribute score related to image brightness may be based on a lighting measurement (e.g., measured in Lux) received from a lighting sensor embedded in the client device 106. Consistent with some embodiments, the analysis module 304 may determine image attribute scores based on the image attribute level measurements received from sensors being above or below certain pre-defined thresholds or within a particular range. Consistent with some embodiments, the image attribute scores may be determined by comparing the image attribute level measurements received from sensors with information in a look-up table. In some embodiments, the analysis module 304 may employ known image processing techniques to analyze the image attributes of the video stream and determine a corresponding score for each the image attributes.

The image attribute scores calculated by the analysis module 304 may individually provide a numerical measure of the quality or level of a particular image attribute, and collectively provide a measure of the overall quality of an image. Accordingly, the attribute scores may be used by the analysis module 304 to calculate an overall image score for a particular image. The analysis module 304 may further compare the overall image score of a particular image to the overall image scores of one or more existing images. The comparison of image scores may provide a user with an indication of how well a particular image may be received by those viewing the image based on how existing images with a similar overall image score have been received. For example, in some embodiments, the analysis module 304 may access or generate statistical information related to the desirability of an image based on the overall image score of that image, and work in conjunction with the feedback module 306 to provide this information to users. For example, in the case of images used for marketplace listings, a marketplace listing may have a 10% increase in sales for images with an overall image score above a certain predetermined threshold. In this example, the analysis module 304 may provide the user with the information related to the increased likelihood of sale if an image captured by the user is below the threshold.

In some embodiments, the analysis modules 304 may work in conjunction with the loyalty module 210 to provide users with loyalty points or other incentives associated with an online marketplace based on the overall image scores of images captured by the client device of the user. In some embodiments, the navigation modules 208 may utilize the overall image scores generated by the analysis modules 304 to rank and order search results presented in response to key word searches for listings published via the network-based content publisher 102. For example, a first listing that includes a first image with a higher overall image score than a second image, corresponding to a second listing, will be presented higher in the search results than the second listing.

The feedback module 306 may generate feedback for the video stream related to the image attribute scores calculated by the analysis module 304. The feedback module 306 may provide textual feedback in real time to the user as the user is in the process of capturing one or more images. The feedback provided by the feedback module 306 may include one or more indicators of the image quality as determined by the image attribute scores, and may further include suggestions (e.g., recommended actions) for users to improve image attribute scores. The one or more indicators may employ text, colors, scores, or combinations thereof to communicate the feedback to a user.

The optimization module 308 may be configured to identify and detect an optimal quality image being produced in a received video stream. To this end, the optimization modules 308 may monitor the image attribute scores of images captured as frames of the live video stream and determine when one or more of the image attribute scores of these images are above a certain predefined threshold. In response to determining that the one or more image attributes are above the predefined threshold, the optimization module 308 may automatically capture one or more images from the video stream. Put differently, the optimization module 308 may cause frames from the video stream to be recorded and saved, without user intervention, in response to determining that an optimal quality image is being produced in the video stream. Accordingly, the capturing of the optimal quality image may comprise selecting a single frame from the video stream that is of optimal quality, and storing the single frame (e.g., an optimal quality image) in a persistent format in a machine-readable medium of the client device 106.

The enhancement module 310 may provide a number of image enhancement services to users of the network-based content publisher 102. For example, the enhancement module 310 may access a particular image, set of images, or video and apply one or more filters to augment, distort, or enhance the color, brightness, contrast, and crispness to the image, set of images, or video. In some instances, the application of the filters may be such that the overall image score of the image is increased. To this end, the particular filters applied to an image by the enhancement modules 310 may be automatically selected based on the image attribute scores of each respective image, and the application of the filters may be such that the image attribute scores corresponding to a particular image are adjusted by the enhancement modules 310 to optimal levels (e.g., above a certain threshold).

The enhancement module 310 may further provide functionality to crop, resize, stretch, and adjust the aspect ratio of images. The enhancement modules 310 may detect a subject of a particular image (e.g., an item to be included in a marketplace listing) and may isolate the subject within the image while removing remaining portions (e.g., background) of the image. The enhancement module 310 may generate a new image using the isolated subject from the original image, and replace the original background. The enhancement modules 310 may allow users to replace the original background with a more aesthetically appropriate background that is of uniform color, pattern, texture, or combination thereof.

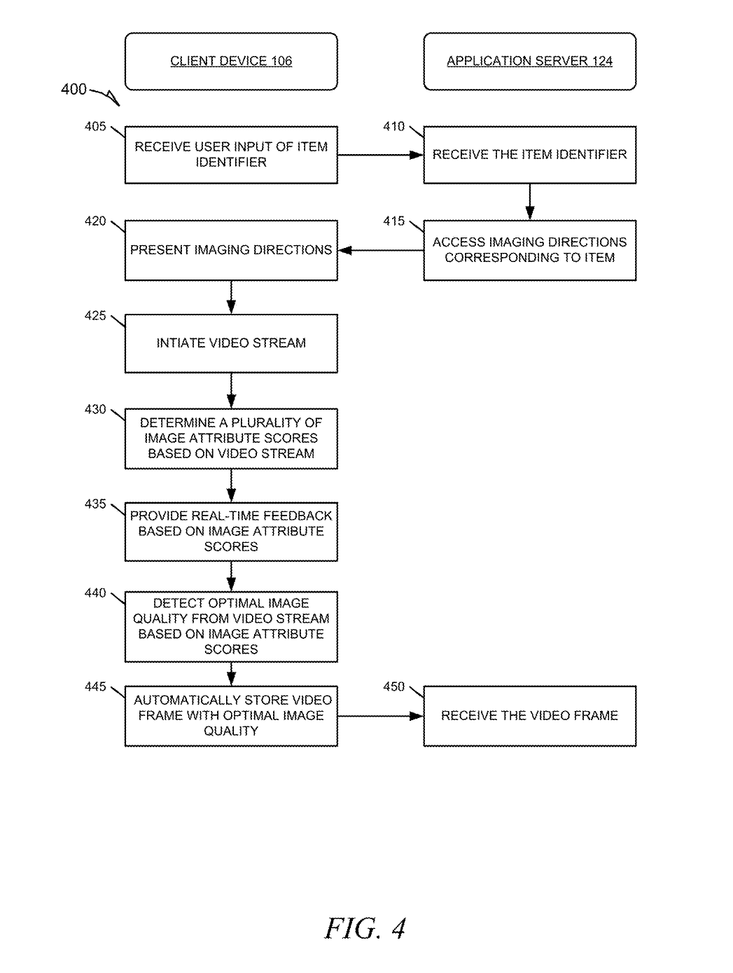

FIG. 4 is an interaction diagram illustrating an example method 400 of capturing an optimal quality image, according to some embodiments. In particular, FIG. 4 illustrates interactions between the client device 106 and the application server 122. In this example embodiment, the client device 106 may include or access at least one identification module 300, analysis module 304, feedback module 306, and optimization module 308, while the application server 122 executes at least one identification module 300 and at least one instructional module 302. However, it shall be appreciated that the inventive subject matter is not limited to this configuration.

At operation 405, the identification module 300 executing on the client device 106 may receive user input of an item identifier (e.g., via a graphical user interface (GUI) displayed on the client device 106). The item identifier is then transmitted to and received by the identification module 300 executing on the application server 122 at operation 410. At operation 415, the instructional module 302 executing on the application server 122 accesses imaging directions (e.g., from the database 130) corresponding to the item identified by the item identifier. The imaging directions convey information that may instruct the user how to photograph or capture (e.g., angles, perspectives, backgrounds) the item identified by the item identifier. The imaging directions may be based on the best known methods for photographing certain items or categories of items. The imaging directions are transmitted to the client device 106 and presented on a display on the client device 106 to the user at operation 420.

At operation 425, a video stream is initiated on the client device 106 to enable the user to capture and record one or more images of the item identified by the item identifier. At operation 430, image attribute scores are calculated by the analysis module 304 based on the video stream. The image attribute scores may, for example, be derived from data output by sensors coupled to the camera, which provide numerical measurements of image attributes.

The image attribute scores determined at operation 430 are used by the feedback modules 306 to provide the user with real-time feedback (e.g., suggestions for improving image attribute scores) prior to the recording and storing of an image (e.g., a single frame of the video stream), at operation 435. At operation 440, the optimization module 308 may detect an optimal quality image occurring in the video stream. The detecting of the optimal quality image by the optimization module 308 may be based on one or more of the image attribute scores being above a predefined threshold. It will be appreciated that in some alternative embodiments, the video stream may be transmitted to the application server 122, and the operations 430, 435, and 440 may be performed by the analysis module 304 and the optimization module 308 executing on the application server 122.

At operation 445, the optimal quality image (e.g., a single frame) is selected from the video stream and stored on the client device 106. At operation 450, the optimal quality image may be transmitted (e.g., uploaded) to the application server 122 for inclusion in a product listing, a social network post, a classified ad, a blog post, or the like. For example, upon being transmitted to the application server 122, the optimal quality image may be utilized to generate, using the marketplace application 124, a product listing page for an item depicted in the optimal quality image.

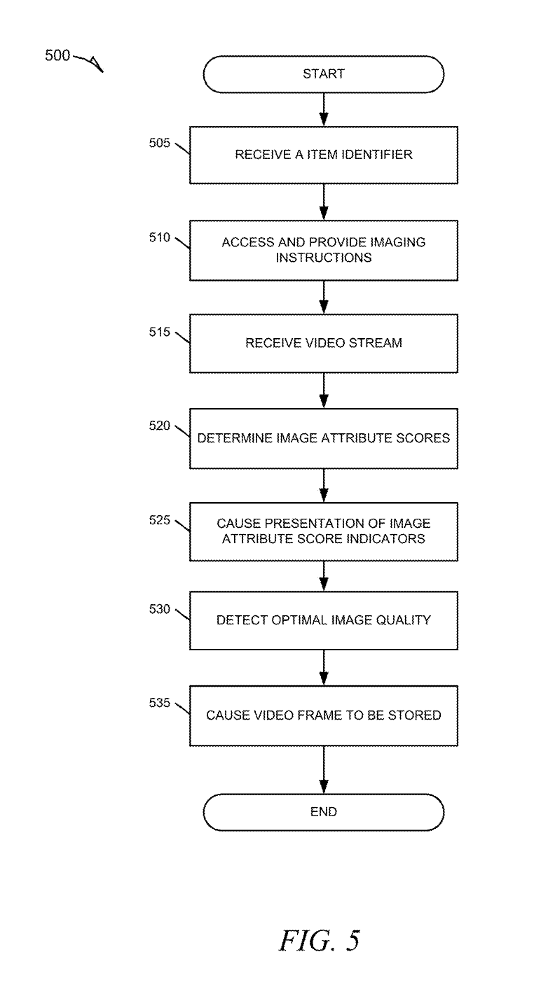

FIG. 5 is a flowchart illustrating a method 500 for optimizing image quality, according to some embodiments. The method 500 may be embodied in computer-readable instructions for execution by one or more processors such that the steps of the method 500 may be performed in part or in whole by the application server 122 or the client device 106. In particular, the method 500 may be carried out by the modules forming the imaging application 126, and accordingly, the method 500 is described below by way of example with reference thereto. However, it shall be appreciated that the method 500 may be deployed on various other hardware configurations and is not intended to be limited to the client device 106, the application server 122, or the modules of the imaging application 126.

At operation 505, an item identifier is received (e.g., by the identification module 300). The item identifier may identify an item intended to be included in an image, set of images, or video captured using a camera embedded in the client device 106. In some embodiments, the item identifier may, for example, be a product identifier such as a UPC, model number, or serial number.

At operation 510, the instructional module 302 accesses imaging directions (e.g., stored in the database 130) and provides the imaging directions to the client device 106 for presentation to a user. The directions may provide the user with instructions related to image setting, background, angle, or orientation or proximity of the camera with respect to the item. The imaging directions may include specific instructions for photographing the particular item identified by the item identifier, or a category of items to which the item belongs.

At operation 515, the analysis module 304 receives a video stream from a camera embedded in the client device 106. The video stream may be produced by a camera application executing on the client device 106. At operation 520, which is an ongoing operation, the analysis module 304 determines image attribute scores for the video stream. The analysis module 304 may determine the image attribute scores based on data output from sensors (e.g., image attribute measurements) coupled to the camera (e.g., embedded in the client device 106). Consistent with some embodiments, the determination of image attribute scores may be based on the image attribute measurements falling within a particular range of values. At operation 525, the feedback module 306 causes the presentation of one or more image attribute score indicators in conjunction with the video stream on the client device 106.

At operation 530, the optimization module 308 may detect an optimal quality image being produced in the video stream based on the image attribute scores (e.g., a portion of the image attribute scores being above a predefined threshold). The optimization module 308 may select the optimal quality image, displayed as a frame of the video stream, from the video stream, and at operation 535 may cause the frame to be stored in a persistent format (e.g., as an image file) in a machine-readable medium of the client device 106.

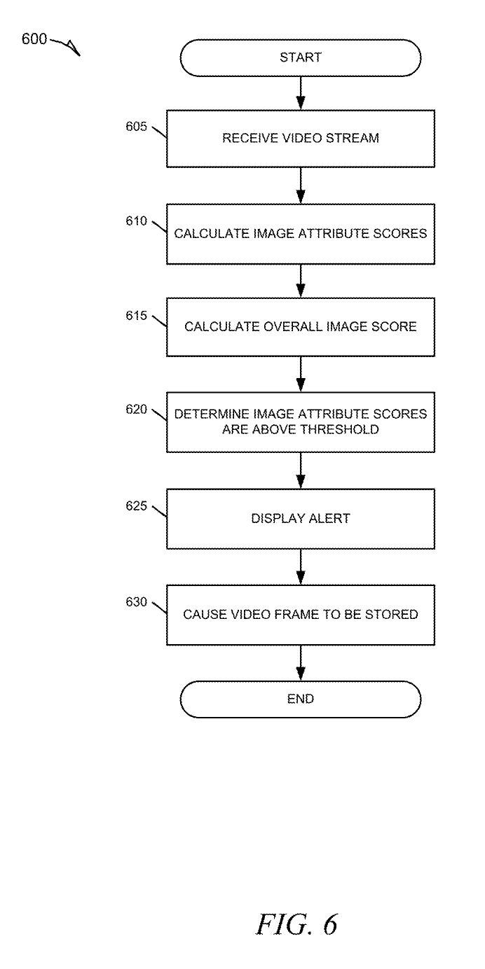

FIG. 6 is a flowchart illustrating a method 600 for capturing an optimal quality image, according to some embodiments. The method 600 may be embodied in computer-readable instructions for execution by one or more processors such that the steps of the method 600 may be performed in part or in whole by the application server 122 or the client device 106. In particular, the method 600 may be carried out by the modules forming the imaging application 126, and accordingly, the method 600 is described below by way of example with reference thereto. However, it shall be appreciated that the method 600 may be deployed on various other hardware configurations and is not intended to be limited to the client device 106, the application server 122, or the modules of the imaging application 126.

At operation 605, the analysis module 304 receives a video stream (e.g., from a camera embedded in the client device 106). At operation 610, which is an ongoing operation, the analysis module 304 calculates image attribute scores for the video stream. The analysis modules 304 may continuously update and recalculate the image attribute scores in real time as changes occur in the video stream.

At operation 615, the analysis module 304 calculates an overall image score for the video stream using the image attribute scores. The overall image score may provide a measure of the overall quality of images being produced in the video stream. In some embodiments, the analysis module 304 may calculate the overall image score by summing the image attribute scores, while in other embodiments, the analysis module 304 may calculate the overall image score by taking a weighted or an unweighted average of the image attribute scores. As with the individual image attribute scores, the analysis modules 304 may continuously update and recalculate the overall image score as the individual image attribute scores are updated and recalculated.

At operation 620, the optimization module 308 determines that at least a portion of the image attribute scores are above a predefined threshold. In some embodiments, the optimization module 308 may determine that a combination of the image attribute scores (e.g., a summation of the image attribute scores or a weighted or unweighted average image attribute score) is above the predefined threshold. In some embodiments, the optimization module 308 may determine that the overall image score is above a predefined threshold.

At operation 625, the optimization module 308 may cause the client device 106 to display an alert (e.g., a pop-up message) to notify the user that the video stream includes an optimal quality image. The optimization module 308 may select the frame occurring in the video stream at the time the determination of operation 620 is made, and at operation 630, cause the frame to be stored (e.g., in the database 130 or a machine-readable medium of the client device 106) in a persistent format (e.g., an image file). The video frame may be automatically stored, without any further action taken by the user, in response to the determination that at least a portion of the image attribute scores are above the predefined threshold.

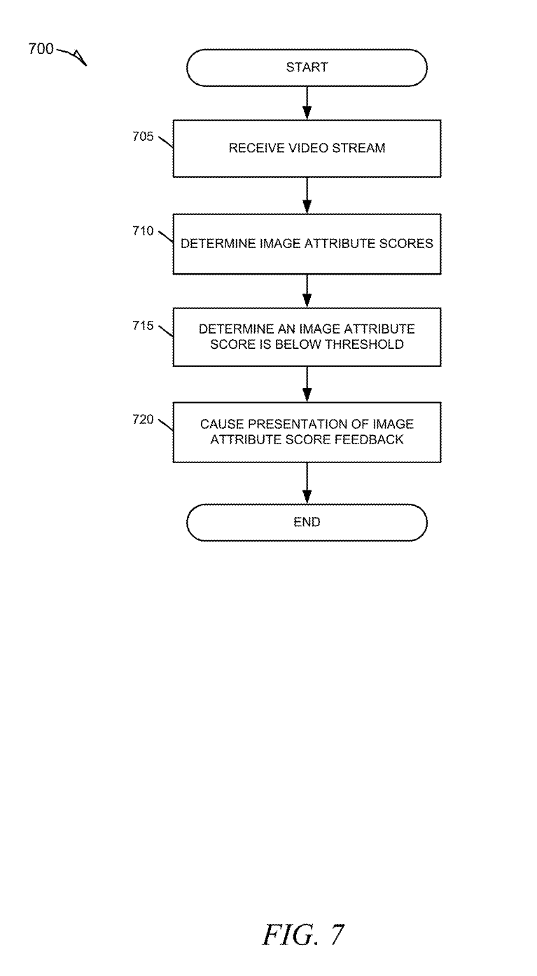

FIG. 7 is a flowchart illustrating a method 700 for providing users with real-time feedback regarding image quality, according to some embodiments. The method 700 may be embodied in computer-readable instructions for execution by one or more processors such that the steps of the method 700 may be performed in part or in whole by the application server 122 or the client device 106. In particular, the method 700 may be carried out by the modules forming the imaging application 126, and accordingly, the method 700 is described below by way of example with reference thereto. However, it shall be appreciated that the method 700 may be deployed on various other hardware configurations and is not intended to be limited to the client device 106, the application server 122, or the modules of the imaging application 126.

At operation 705, the analysis module 304 receives a video stream (e.g., from a camera embedded in the client device 106). At operation 710, which is an ongoing operation, the analysis module 304 determines image attribute scores for the video stream.

At operation 715, the feedback module 306 determines that an image attribute score (e.g., determined at operation 710) is below a predefined threshold. Prior to capturing (e.g., selecting and storing) an image (e.g., a single frame of the video stream) or video (e.g., multiple frames in the video stream), the feedback module 306 may provide the user (e.g., cause to be presented on the client device 106) with real-time feedback relating to the video stream at operation 720. The feedback provided by the feedback module 306 may indicate that the image attribute score is below the predefined threshold, and may include suggestions for improving such image attribute scores. For example, the feedback module 306 may provide a user with feedback indicating that the angle of the image is askew (e.g., more than five degrees rotated from an orientation of the subject) based on the image attribute score of the angle, and suggesting that the user adjust the angle accordingly. In some embodiments, providing feedback to the user may include causing the presentation of one or more image attribute score indicators in conjunction with the video stream on the client device 106.

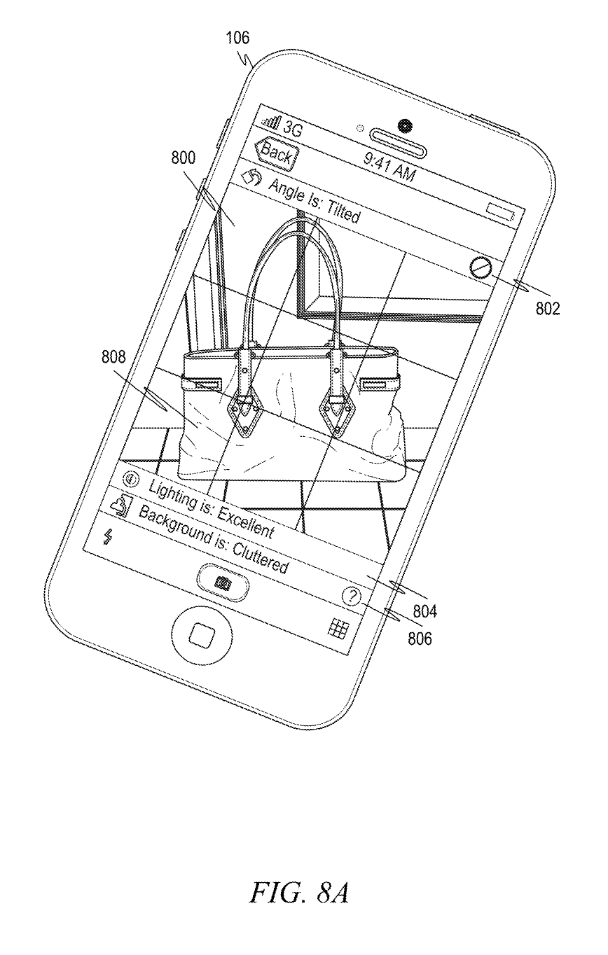

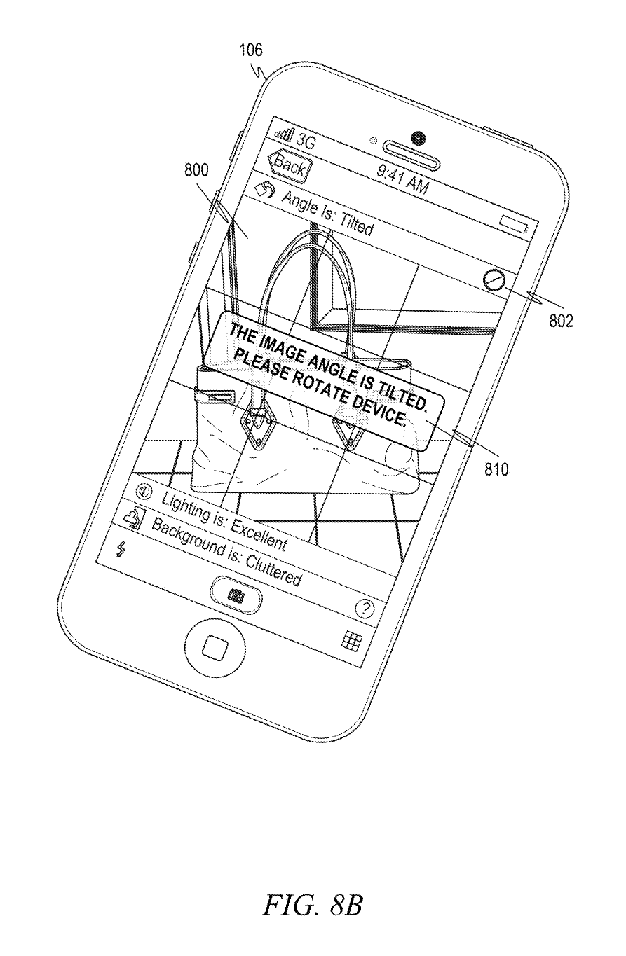

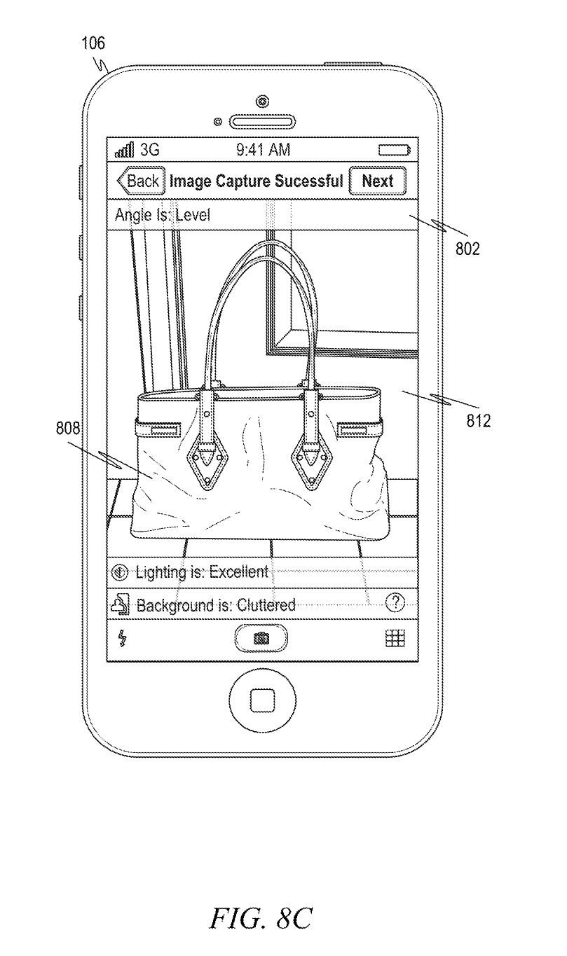

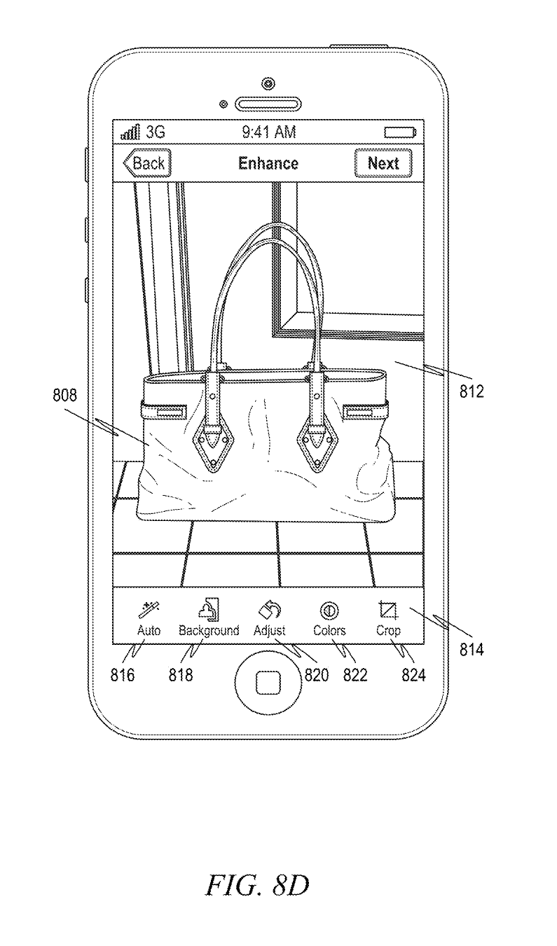

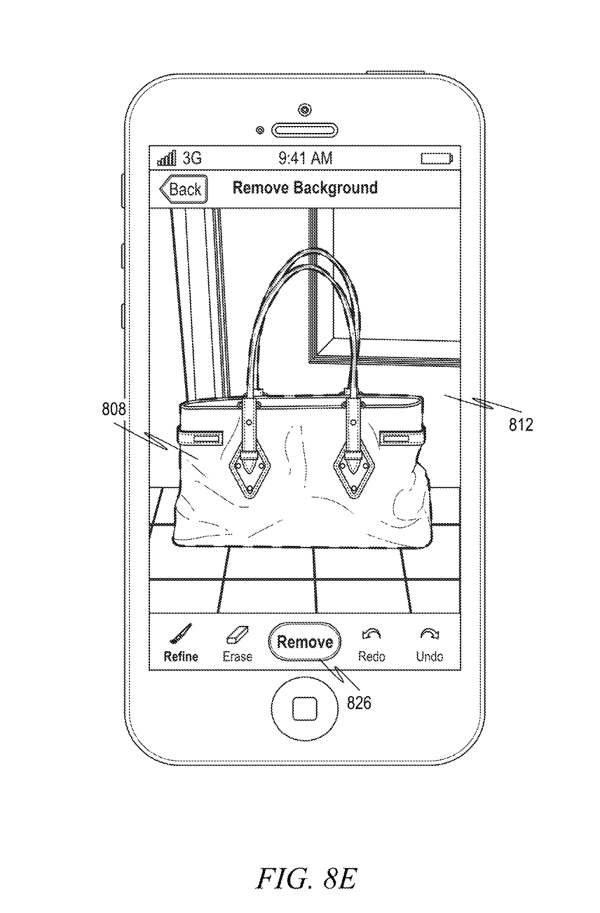

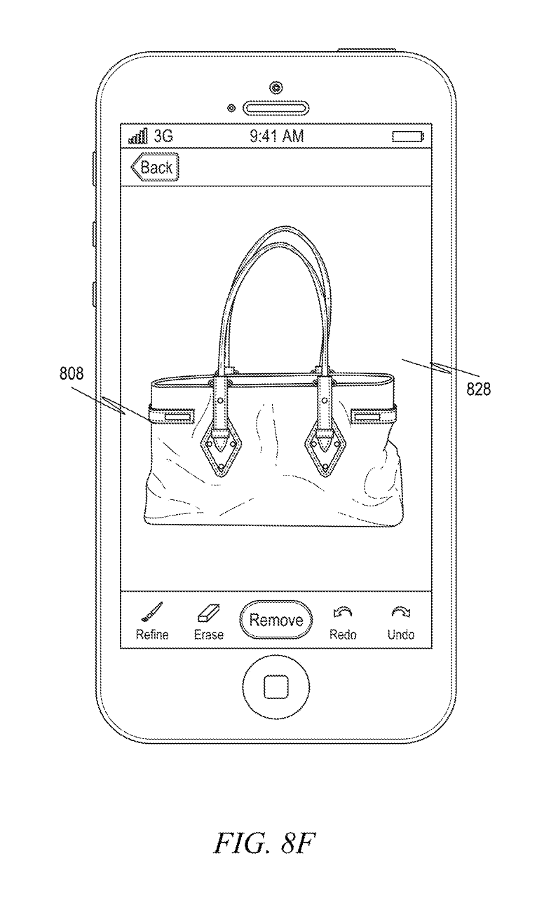

FIG. 8A is an interface diagram illustrating a video stream 800 being produced on the client device 106 along with indicators of image attribute scores, according to some embodiments. In particular, FIG. 8A illustrates indicators 802, 804, and 806 of image attribute scores corresponding to the angle, lighting, and background, respectively. Specifically, the indicator 802 provides a negative indication for image angle (“Tilted”), the indicator 804 provides a positive indication (“Excellent”) for image lighting, and the indicator 806 provides a negative indication for background (“Cluttered”).

As shown in FIG. 8A, the basis for the negative indication related to image angle (e.g., “Tilted) is that the client device 106 is positioned at an angle that is askew relative to an item 808 (e.g., a purse), which is the subject of the image. Regarding the negative indication provided by the indicator 806, the background (e.g., the remainder of what is being presented) of the video stream 800 contains multiple visual textures and patterns that may distract viewers from the intended subject of the image (e.g., item 808). Hence, the indication of a “Cluttered” background for the video stream 800 provided by the indicator 806. The indicators 802, 804, and 806 may be displayed and updated in real time as the angle, lighting, background and other factors affecting image quality are changed. Because the indicators 802, 804, and 806, which provide an indication of image attribute scores, are being presented in real time, the user of the client device 106 will be incentivized to adjust the manner in which he is attempting to photograph or capture video of the item 808 in order to improve the image attribute scores, and thereby improve the overall quality of the images produced in the video stream 800.

FIG. 8B is an interface diagram illustrating the video stream 800 being produced on the client device 106 along with feedback 810 related to an image attribute, according to some embodiments. In particular, the feedback 810, which relates to the image angle (e.g., corresponding to indicator 802), suggests that the user operating the client device 106 rotate the client device 106 so as to improve the image angle. The feedback 810 may be provided by the feedback module 306 in response to determining that an image attribute score (e.g., the image attribute score for image angle) is below a predefined threshold.

FIG. 8C is an interface diagram illustrating an optimal quality image 812 captured from the video stream 800 produced on the client device 106, according to some embodiments. As shown in FIG. 8C, the client device 106 has been rotated in such a manner that it is no longer askew relative to the item 808, and in response, the indicator 802 has been updated (e.g., based on an updated image attribute score calculated by the analysis module 304) to reflect that the angle is “Level.”

Further, the optimization module 308 has caused the client device 106 to select and store the image 812, which is a single frame from the video stream 800, in response to the angle adjustment. The image 812 may be selected and stored by the optimization module 308 based on at least a portion of the image attribute scores calculated by the analysis module 304 being above a predefined threshold. The image 812 may be selected from the video stream 800 at the moment the image attribute scores are determined to be above the predefined threshold. For example, the optimization module 308 may select and store the image 812 at the moment the client device 106 is rotated thereby causing the image attribute score for angle to rise above a certain threshold (e.g., level) while maintaining the same image attribute score for lighting, which is already above the threshold (e.g., excellent), and background, which is still indicated as being “cluttered.”

FIG. 8D is an interface diagram illustrating a menu 814 including options for enhancing the image 812, according to some embodiments. As shown in FIG. 8D, the menu 814 includes an auto-enhance button 816, a background button 818, an angle adjust button 820, a color button 822, and a crop button 824. The auto-enhance button 816 may be operable to provide the user ability to automatically adjust the image attributes of the image 812 to an optimal level as determined by the image attribute scores calculated by the analysis module 304. The background button 818 may be operable to provide functionality that allows a user to edit the background of the image 812 (e.g., remove or replace). The angle adjust button 820 may be operable to provide functionality that allows the user to adjust the angle of the image 812. The color button 822 may be operable to provide functionality that allows the user to adjust the colors of the image 812. The crop button 824 may be operable to provide the user with the ability to crop or resize the image 812.

FIG. 8E is an interface diagram illustrating an image enhancement feature, according to some embodiments. In particular, FIG. 8E illustrates a background removal operation initiated in response to the selection of the background button 818. As illustrated in FIG. 8E, the subject of the image 812 (e.g., the item 808) may be identified using known image recognition techniques, and visually distinguished (e.g., highlighted) from the remainder of the image 812, which constitutes the background. Subsequent to the subject being identified, the remaining portions of the image may be removed in response to a user selection of a button 826.

FIG. 8F is an interface diagram illustrating an enhanced image 828, consistent with some embodiments. The enhanced image 828 is the result of the background removal operation performed on the image 812 in response to selection of the button 826. As shown, the item 808, which is the subject of the image 812 (and the enhanced image 828), has been isolated and the remaining portion of the image 812 (e.g., the background) has been replaced with a uniform white background. In some other embodiments, the enhancement module 310 may provide the user with the option to replace the background with one of several uniformly colored or textured background selections (e.g., via drop-down menu).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

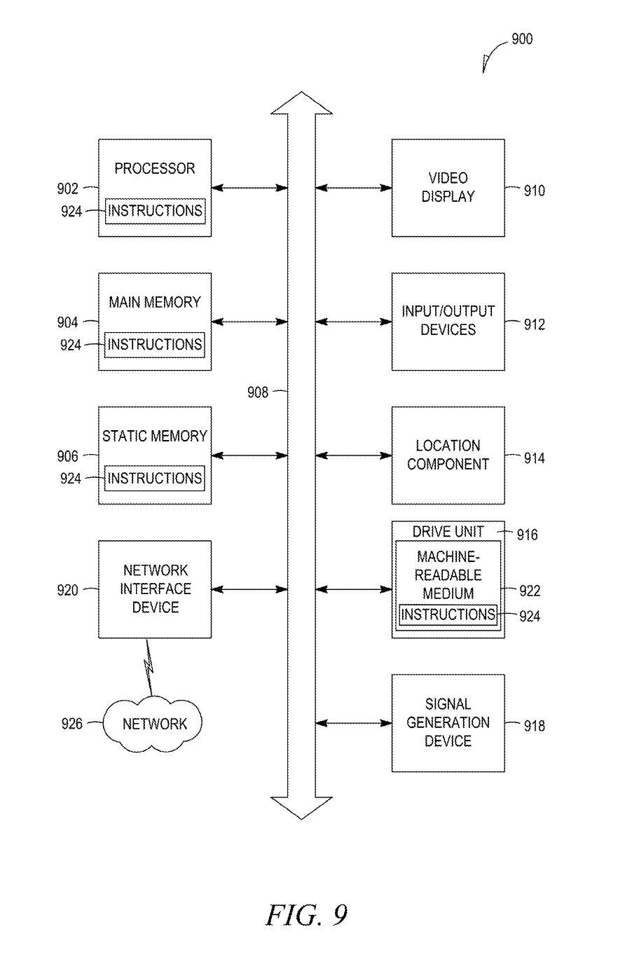

FIG. 9 is a diagrammatic representation of a machine in the example form of a computer system 900 within which a set of instructions for causing the machine to perform any one or more of the methodologies discussed herein may be executed. The computer system 900 may correspond to client device 106, third party server 114, or application server 122, consistent with some embodiments. The computer system 900 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display 910 (e.g., a liquid crystal display (LCD) or a cathode ray tube (CRT)). The computer system 900 also includes one or more input/output (I/O) devices 912, a location component 914, a drive unit 916, a signal generation device 918 (e.g., a speaker), and a network interface device 920. The I/O devices 912 may, for example, include a keyboard, a mouse, a keypad, a multi-touch surface (e.g., a touchscreen or track pad), a microphone, a camera, and the like.

The location component 914 may be used for determining a location of the computer system 900. In some embodiments, the location component 914 may correspond to a GPS transceiver that may make use of the network interface device 920 to communicate GPS signals with a GPS satellite. The location component 914 may also be configured to determine a location of the computer system 900 by using an internet protocol (IP) address lookup or by triangulating a position based on nearby mobile communications towers. The location component 914 may be further configured to store a user-defined location in main memory 904 or static memory 906. In some embodiments, a mobile location enabled application may work in conjunction with the location component 914 and the network interface device 920 to transmit the location of the computer system 900 to an application server or third party server for the purpose of identifying the location of a user operating the computer system 900.

In some embodiments, the network interface device 920 may correspond to a transceiver and antenna. The transceiver may be configured to both transmit and receive cellular network signals, wireless data signals, or other types of signals via the antenna, depending on the nature of the computer system 900.

### Machine-Readable Medium

The drive unit 916 includes a machine-readable medium 922 on which is stored one or more sets of data structures and instructions 924 (e.g., software) embodying or used by any one or more of the methodologies or functions described herein. The instructions 924 may also reside, completely or at least partially, within the main memory 904, the static memory 906, and/or within the processor 902 during execution thereof by the computer system 900, with the main memory 904, the static memory 906, and the processor 902 also constituting machine-readable media.

Consistent with some embodiments, the instructions 924 may relate to the operations of an operating system (OS). Depending on the particular type of the computer system 900, the OS may, for example, be the iOS® operating system, the Android® operating system, a BlackBerry® operating system, the Microsoft® Windows® Phone operating system, Symbian® OS, or webOS®. Further, the instructions 924 may relate to operations performed by applications (commonly known as “apps”), consistent with some embodiments. One example of such an application is a mobile browser application that displays content, such as a web page or a user interface using a browser.

While the machine-readable medium 922 is shown in an example embodiment to be a single medium, the term “machine-readable medium” may include a single medium or multiple media (e.g., a centralized or distributed database, and/or associated caches and servers) that store the one or more data structures or instructions 924. The term “machine-readable medium” shall also be taken to include any tangible medium that is capable of storing, encoding, or carrying instructions (e.g., instructions 924) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 924 may further be transmitted or received over a network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying the instructions 924 for execution by the machine, and includes digital or analog communications signals or other intangible media to facilitate communication of such software.

### Video Creation System for Generating an Optimal User-Submitted Video Clip

In some embodiments, the user-submitted content may be video content, such as a video clip, which the user wishes to upload and share, in order to achieve business related goals, such as advertising, entertainment and sales. In this case, smart video templates will be provided to the user by a video creation system, in order to direct the user according to the right business logic and allowing the user to create an appropriate video clip more quickly and easily.

For example, if the user wishes to advertise a product of interest for the purpose of sales and recommendation using a video clip, after calculating several parameters, the system will build the right format and template to guide the user as to how achieve the best results. These parameters may include the industry being targeted (E-Commerce/Travel/Food etc.), the type of activity (e.g., selling a product, displaying a video ad, promotion for an upcoming event etc.) or the medium where the video content will be published (e.g. a website, a product page, Facebook, Instagram, etc.). Guiding the user via smart templates can drastically reduce the cost for the video creator, as no professional video personnel are required to achieve high-quality videos.

An advantage for viewers of videos that are created using the system video templates is that they are broken into unique segments “behind the scenes.” This enables viewers to “swipe” a video clip using hand-gestures in order to skip to the next segment, similar to swiping when viewing a gallery of photos, which is common practice today.

The video creation system can present to the user a set of the most optimal photos extracted from the video stream, using the same determination method of image attribute scores performed by the analysis module 304 described above. The user can then select specific photos from these most optimal photos extracted by the system, and use them for purposes such as setting a cover photo (using a selected top photo which is displayed online) for their video clip. The user may also display the photos under the video clip on a web page or within social networks, which can improve the ranking of the video clip or of the web page in search engine results (a form of Search Engine Optimization, or “SEO”).

At the first step, the video creation system divides each recorded video clip into several segments (e.g. 3-5 segments). At the next step, the segments are recomposed to create different variations of the recorded video clip. For example, the video creation system can automatically create a 15 seconds long video clip to be used on Instagram (a platform which limits the length of videos to no more than 15 seconds) by selecting the minimal number of segments that are most representative for such a short video, based on the directions of the templates. This way, several video combinations can be generated from a single video that has been recorded by the user. Another example is automatically creating a shorter and more concise “preview”/“teaser” video segment from a longer, original video clip.

In some cases, a user may wish to purchase an item shown through a video or a photo, or inspired by the aforementioned video or photo. However, the timing of viewing the item is not conducive for making a purchase (e.g., when browsing using a mobile phone while being on the bus). In his case, the system will enable the user to click on a “remind me later” button, which when clicked upon, will offer several options such as “Remind me later today,” “Remind me tomorrow,” “Remind me on someone's birthday,” “Remind me when we get close to the holidays,” etc. At a later time as selected by the user, the system will contact the user (e.g., using email, push notification or other forms of notification) and present the product at the selected time in a convenient form for the user.

The proposed video creation system can also allow the user to embed a product into the video clip, as an integral part. Video creation templates may guide the user to tag virtual representations (such as video clips, images, title and description) of products that are featured within the video with certain meta-data about them (e.g., product title, Universal Product Code, etc.). Tagging a product within the video will be similar to tagging a person on a social network (e.g. Facebook etc.).

The proposed video creation system can also automatically generate individual product videos from a longer video that features several products or topics. If a user is showcasing several products within the video, the proposed video creation system will automatically divide the recorded video stream into separate videos, each of which focusing on a different product. The result of this process is the creation of several independent “product-related” video clips, each focused on a specific product. These product-related video clips can then be embedded in a wide range of channels, such as product pages in retailers' websites.

The proposed video creation system can also automatically enrich videos and photos with a wide variety of meta-data. For example, once a video is created featuring a specific product that was tagged by the user, the system can extract meta-data related to the featured product from the website of a retailer that is selling it, and attach it to the product video. By adding this meta-data to videos, it has the benefit of making the videos and photos searchable by search engines, thereby allowing recommendation engines to suggest them in merchandising recommendations, etc.

The proposed video creation system can also display the product featured in the video on top of the video clip, during the time when the product is being discussed in the video. This way, viewers can see information about the product and purchase the product by clicking on it. While the video is being played, a list of products featured in the video will be shown below the video in the form of “product cards,” which are a means of visualizing products by showing the product's title, photo, and other relevant information in a streamlined fashion. The order in which the product cards are listed will be dynamically changed, based on which products are being shown in the video at any given time. For example, if a specific product is currently being discussed in the video, it will “float” to the top of the products list (first position below the video).

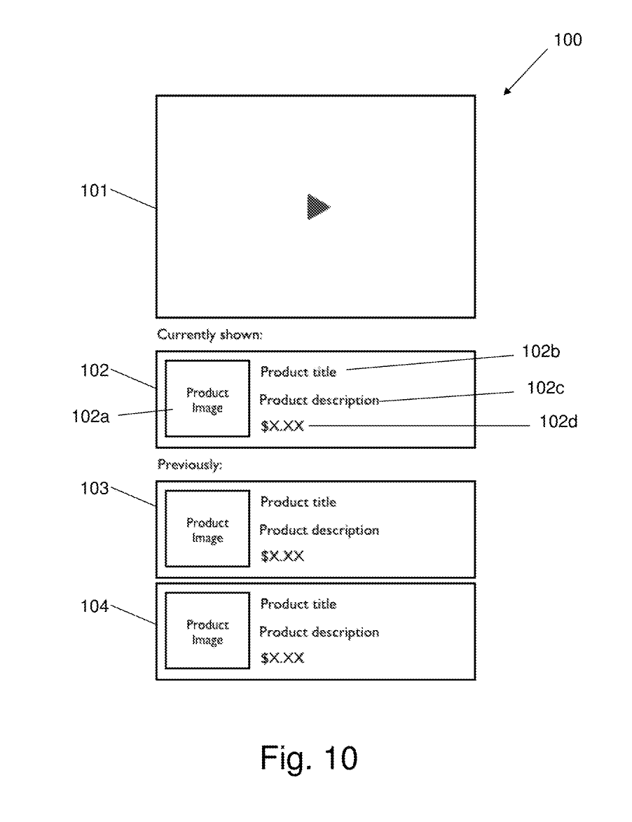

FIG. 10 shows a schematic view of a product card. The product card 100 includes a first field 101 in which products are presented (currently shown) during playing a video clip. Several products that are shown in different times during the played video clip are presented in separate windows 102-104, where the product presentation in window 104 precedes the product presentation in window 103 and the product presentation in window 103 precedes the product presentation in window 102 etc. Each product presentation includes an image 102a of the product, the title 102b of the product, the description 102c of the product and the price 102d of the product.

The proposed video creation system offers a feature of “collaborative video.” “Collaborative video” is a video that is created together by multiple users, where its segments can be recorded in different times and locations, after which the system “stitches” them together into a single, cohesive video. For example, user 1 can create a video consisting of various segments he recorded, and leave blank “placeholder” segments within the video to be filled in by other users. User 2 can then edit this video, record his own segments, and insert them into the “placeholders.” The system is able to then automatically synthesize these collaboratively created segments into a single, unified video. There can be a large number of users collaborating together to create a video. Users generating the initial video can define permission rights for certain “placeholder” sections, thereby only permitting users with certain access/clearance level to make modifications. For example, “placeholders” can be set to be editable by anyone (“Public” setting), by specific authorized persons (“Person X” setting), a group of people (“Group X” setting) etc.

The proposed video creation system is also able to achieve optimal videos by analyzing the video stream in real-time and making automatic optimizations, including:

a) Automatically adjust the camera of the mobile device according to the goal of the video (e.g. close-up/longshot etc.) to achieve optimal results.
b) Automatically activate the flash light of the mobile device to improve lighting conditions in the video.

An additional feature of the video creation system is to enable users to broadcast their computer or mobile screen while engaged in an activity (for example, during shopping) to a group of users and share their experiences. Sharing may be done using:

Screen sharing—sharing a live or previously recorded video stream of the user's screen;
Voice sharing—users can narrate their experience to the viewers, share their thoughts, and solicit feedback and advice from viewers (e.g. “which of these two products should I buy?”);
c) “Reaction” video stream—sharing of the video stream from another camera that is recording a video of their face and reactions while engaging in this activity (e.g., capture the excitement on their face when they found out that their favorite retailer is having a sale on their favorite line of products).

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

1. A method for capturing and optimizing images and video streams comprising:
a) receiving a video stream from a camera associated with a client device;
b) calculating a plurality of image attribute scores for the video stream;
c) determining, by a processor of a machine, that at least a portion of the plurality of image attribute scores are above a predefined threshold; and
d) in response to determining that at least the portion of the plurality of image attribute scores are above the predefined threshold, causing the client device to automatically store a particular video frame included in the video stream in a persistent format in a machine-readable medium of the client device.

2. The method of claim 2, further comprising causing the client device to display an alert in response to determining that at least the portion of the plurality of image scores are above the predefined threshold, the alert notifying a user that the video stream includes an image of optimal quality.

3. The method of claim 1, further comprising calculating an overall image score for the particular video frame using the plurality of image attribute scores, the overall image score providing an overall measure of quality of the particular video frame.

4. The method of claim 1, further comprising:
a) determining that at least one image attribute score of the plurality of image attribute scores is below a predefined threshold;
b) in response to determining that the at least one image attribute score of the plurality of image attribute scores is below the predefined threshold, generating textual feedback including a suggestion to improve the at least one image attribute score; and
c) causing the textual feedback to be displayed on the client device.

5. The method of claim 1, further comprising causing the client device to present an indicator of at least one of the plurality of image attribute scores.

6. The method of claim 1, further comprising:
a) receiving an item identifier, the item identifier identifying an item included in the video stream;
b) accessing imaging directions corresponding to the item identifier, the imaging directions relating to a manner in which the item is to be depicted in the video stream; and
c) causing the imaging directions to be presented on the client device.

7. The method of claim 6, wherein the imaging directions include analytic data regarding previous images depicting similar items.

8. The method of claim 1, wherein the plurality of image attribute scores provide a measure of at least one of angle, brightness, color, composition, saturation, background clutter, or resolution.

9. The method of claim 1, wherein the calculating of the plurality of image attribute scores is performed continuously until the determining that at least the portion of the plurality of image attribute scores is above the predefined threshold.

10. The method of claim 1, further comprising:
a) causing the particular video frame to be uploaded to a network server; and
b) generating a product listing page using the particular video frame, the product listing page corresponding to an item depicted in the particular video frame.

11. The method of claim 10, wherein the plurality of image attribute scores are used to rank the product listing page in a list of search results.

12. A system for capturing and optimizing images and video streams comprising:
a) a machine-readable medium;
b) an analysis module, including at least one processor, configured to receive a video stream from a camera, the analysis module further configured to calculate a plurality of image attribute scores for the video stream; and
c) an optimization module configured to determine that a particular combination of the plurality of image attribute scores is above a predefined threshold, the optimization module further configured to cause a particular video frame included in the video stream to be stored in a persistent format in the machine-readable medium in response to determining that the particular combination of the plurality of image attribute scores is above a predefined threshold.

13. The system of claim 12, wherein the particular video frame is stored in the machine-readable medium without intervention from a user.

14. The system of claim 12, wherein the analysis module calculates the plurality of image attributes scores using data received from a plurality of sensors coupled to the camera.

15. The system of claim 14, wherein the analysis module calculates the plurality of image attribute scores based on image attribute measurements provided by the plurality of sensors being in a particular range.

16. The system of claim 12, wherein the analysis module is further configured to calculate an overall image score for the particular video frame, the overall image score providing a measure of overall quality of the particular video frame.

17. The system of claim 15, wherein the particular combination of the plurality of image attribute scores is the overall image score.

18. The system of claim 12, further comprising an instructional module configured to perform operations comprising:
a) determining that a particular image attribute score of the plurality of image attribute scores is below a predefined threshold;
b) in response to determining that the particular image attribute score of the plurality of image attribute scores is below the other predefined threshold, generating textual feedback including a suggestion to improve the particular image attribute score; and
c) causing the textual feedback to be displayed on a client device associated with the camera.

19. The system of claim 12, further comprising:
a) an identification module configured to receive an item identifier, the item identifier identifying an item included in the video stream; and
b) an instructional module configured to access imaging directions corresponding to the item, the instructional module further configured to cause the imaging directions to be presented in conjunction with the video stream, the imaging directions relating to a manner in which the item is to be depicted in the video stream.

20. A non-transitory machine-readable storage medium comprising instructions that, when executed by one or more processors of a machine, cause the machine to perform operations comprising:
a) receiving a video stream from a camera associated with a client device;
b) calculating a plurality of image attribute scores for the video stream; determining that at least a portion of the plurality of image attribute scores are above a predefined threshold; and
c) in response to determining that at least the portion of the plurality of image attribute scores are above the predefined threshold, causing the client device to automatically store an image in a persistent format in a machine-readable medium of the client device, the image being a single frame from the video stream.

21. A method for capturing and optimizing a video stream comprising:
a) receiving a video stream from a camera associated with a client device:
b) providing to the user of said client device video templates containing video-recording directions which are adapted to predetermined criteria that correspond to:
b.1) the purpose of video-recording;
b.2) the type of activity to be presented in said video stream;
b.3) the medium where the video content will be published.

22. The method of claim 21, further comprising:
a) presenting to the user one or more top photos, being the most optimal photos extracted from the recorded video stream;
b) allowing the user to add a selected top photo as cover photo to said recorded video stream, or to use a selected top photo being displayed online.

23. The method of claim 21, further comprising:
a) dividing each recorded video clip into several segments;
b) automatically recomposing said segments to create variations of the recorded video clip.

24. The method of claim 21, further comprising:
a) Tagging one or more virtual representations of products using related meta-data;
b) embedding one or more tagged virtual representations into a video clip using the video template.

25. The method of claim 21, further comprising automatically adding meta-data to the video clip.

26. The method of claim 21, wherein the embedded images and select meta-data of a product are displayed on top of the video clip, while the product is being discussed in said video clip.

27. The method of claim 21, further comprising enabling multiple users to create videos collaboratively by recording segments in different times and locations and automatically synthesizing them into a single, cohesive video.
